(19) United States
(12) Patent Application Publication
(10) Pub. No.: US 2021/0065006 A1
(43) Pub. Date: Mar. 4, 2021

(54) CONSTRUCTION SEQUENCING OPTIMIZATION

(71) Applicant: HEXAGON TECHNOLOGY CENTER GMBH, Heerbrugg (CH)

(72) Inventors: Nicholas BADE, Widnau (CH); Bernd REIMANN, Heerbrugg (CH)

(73) Assignee: HEXAGON TECHNOLOGY CENTER GMBH, Heerbrugg (CH)

(21) Appl. No.: 16/551,246

(22) Filed: Aug. 26, 2019

(51) Int. Cl. G06N 3/08; G06N 20/00; G06F 17/50

(52) U.S. Cl. CPC G06N 3/084; G06F 17/5004; G06N 20/00

(57) ABSTRACT

Disclosed are methods and systems for training an artificial-intelligence structure based on designs of past fabrication or construction projects, and for automatically generating, by the trained artificial-intelligence structure and based on inputs related to an actual fabrication or construction project, designs for the actual project.

### FIELD OF THE INVENTION

The present invention pertains to a system for construction sequencing optimization and to a computer-implemented method of construction sequencing optimization that allow efficient planning and managing of fabrication or construction projects. In some embodiments, the system is configured to train a neural network structure based on past projects to automatically generate actual designs based on inputs related to an actual project.

### BACKGROUND OF THE INVENTION

Professional industrial construction software exists that allows efficient planning and managing fabrication and construction projects. One example of such a software is Intergraph's Smart© Construction software.

With the existing software, Installation Work Packages (IWP) have to be defined and scheduled by the user of the software, which is a time-consuming and repetitive task. The IWP are issued to the crews to guide them on work required. For the construction of large structures, such as e.g. a refinery complex or a power plant, there are several construction work areas (CWA) defined which are geographical areas of logically associated work. Within each CWA, there are several construction work packages (CWP) defined which define the major work packages (e.g. civil, structural, electrical, piping, instrumentation etc.) and give a Level 3 Work Breakdown Structure (WBS) in the Master Schedule. Each CWP is divided into different IWP, wherein for each individual object (i.e. each individual pipe, flange, cable, etc.) it is precisely defined when it will be installed and by which crew.

Using the Smart© Construction platform, 3D models are derivable based on the CWP and CWA. These 3D models define the layout of the structure and comprise all objects like pumps, valves, electrical parts and supporting structures. On the side of the design, the spatial location and physical connection of these objects, their supplier, an ID number, material, weight and other factors are known. From this information, IWP are derived and scheduled. An IWP is a bin of hundreds or thousands of objects such that they form comprehensive clusters and can be installed together. IWP often (only) can be executed in sequential order. The design of such IWP follows some engineering best-practices and logical factors: for example, heavy objects are installed before light objects, bigger objects before smaller parts and building starts at the ground and advances towards the top (i.e. higher floors). However, the engineering best-practices and logical factors are not codified. Based on these constraints and best-practices, a human engineer uses this information to manually design the IWP. This is a time-consuming and demanding task, and it would be desirable to have this task at least partially automated using artificial intelligence (AI).

Existing software such as Intergraph Smart© Construction can help visualize the building process and show Gantt charts where issues can be identified manually. However, there is no solution available which automatically generates IWP at a large scale. Solutions exist that work at a very limited scale and can provide optimal construction sequencing results on an academic and experimental level. For instance, the paper ‘Optimization of Construction Sequence Using Genetic Algorithm’ by Mohammed Naveed and B. Harish Naik describes an approach that does not rely on human input but uses metaheuristics only. However, these approaches fail when it comes to automatic optimal sequencing of large IWP as they appear frequently at real-world construction sites of large structures (like power plants, refineries etc.). None of these approaches uses human feedback to improve over time.

### SUMMARY OF VARIOUS EMBODIMENTS

In accordance with one embodiment of the invention, a smart virtual designer system for construction sequencing optimization that is configured to train an artificial-intelligence (AI) structure to automatically generate actual designs based on inputs related to an actual fabrication or construction project, comprises a design database storing existing data of past fabrication or construction projects, the existing data comprising a plurality of data sets comprising at least one of past designs and past inputs. The system further comprises at least one server comprising a tangible, non-transitory computer-readable medium having stored thereon a generative virtual designer comprising the neural network structure including at least an autoencoder and an encoder-decoder pair, the autoencoder comprising a first encoder and a first decoder, and the encoder-decoder pair comprising either the first encoder and a second decoder or the first decoder and a second encoder. The design database and the server are configured to interact so that the existing data are provided to the autoencoder. The autoencoder is configured to encode and decode the existing data, i.e. at least a subset of the plurality of data sets, to learn a representation of the existing data (or the data sets) in a low-dimensional space, wherein the encoding and decoding of the data sets comprises an encoding, by the first encoder, of the data sets to low-dimensional representations, and a decoding, by the first decoder, of the low-dimensional representations. The system comprises a data input device configured to receive actual input data related to an actual fabrication or construction project and to provide the actual input data to the encoder-decoder pair. The encoder-decoder pair is configured to encode the actual input data to an actual low-dimensional representation and to decode the actual low-dimensional representation. The system is configured to generate output data based on the result of the decoding of the actual low-dimensional representation.

In various alternative embodiments, the output data is presented to a user of the system, and/or stored in the computer-readable medium.

Additionally or alternatively, the output data comprises at least one of resource ID of components in each task, construction activity, expected start and end date, equipment involved, pre-requirements, and cost.

According to some embodiments, the encoder-decoder pair comprises the first decoder and a second encoder, the existing data comprises a plurality of past designs generated by one or more human designers, the design database and the server are configured to interact so that the past designs are provided to the autoencoder, and based on the encoding and decoding of the plurality of past designs, the autoencoder learns a representation of the past designs in a low-dimensional space.

In some embodiments each design comprises at least an Installation Work Package (IWP) of a fabrication or construction project and a schedule for the IWP.

Additionally or alternatively, the plurality of data sets comprises at least 100 past designs, wherein the autoencoder is configured to encode and decode at least 100 past designs to learn a representation of the past designs in a low-dimensional space.

According to some embodiments, the encoder-decoder pair comprises the first encoder and a second decoder, the existing data comprises a plurality of past inputs comprising at least one of lists of crews and components of past fabrication or construction projects, the design database and the server are configured to interact so that the past inputs are provided to the autoencoder, and based on the encoding and encoding of the plurality of past inputs, the autoencoder learns a representation of the past inputs in a low-dimensional space.

Additionally or alternatively, the existing data is generated by one or more human designers, the existing data particularly comprising past designs of past fabrication or construction projects and/or past inputs for past fabrication or construction projects, the inputs e.g. comprising lists of crews and components.

Additionally or alternatively, based on the encoding and decoding of the plurality of past designs, the autoencoder learns a representation of the designs in a low-dimensional space.

Additionally or alternatively, the plurality of existing designs comprises at least 10 or at least 100 designs.

Additionally or alternatively, the AI structure is or comprises a neural network structure. According to some embodiments, the AI or neural network structure comprises a generative adversarial network (GAN).

Additionally or alternatively, the actual input data comprises at least one of lists of crews and components of the actual fabrication or construction project.

Additionally or alternatively, the output data is provided to a user of the system, and the system is configured to receive feedback from the user, wherein the feedback is used for a reinforced learning process in the training of the neural network structure. Optionally, the feedback is codified in terms of a reward function for a Q-learning-approach, e.g. using a Q-table. Additionally or alternatively, the feedback comprises information on whether a constraint is violated.

Additionally or alternatively, the computer-readable medium has stored a simulation software, the output is provided to the simulation software, the simulation software is configured to determine whether given constraints are violated by the output and to provide feedback comprising information on whether a constraint is violated, and the system is configured to use the feedback for a reinforced learning process in the training of the neural network structure. Optionally, the feedback is codified in terms of a reward function for a Q-learning-approach.

Additionally or alternatively, the computer-readable medium has stored a metaheuristic virtual designer comprising one or more metaheuristic algorithms, wherein the virtual designer generator is configured to generate, based on past design inputs and using the one or more metaheuristic algorithms, a multitude of design alternatives, wherein the multitude of design alternatives are provided to the generative virtual designer and used in the training of the neural network structure.

Additionally or alternatively, the computer-readable medium has stored a metaheuristic virtual designer comprising one or more metaheuristic algorithms, wherein the metaheuristic virtual designer is configured to generate, based on the output data and using the one or more metaheuristic algorithms, an optimal design for the actual fabrication or construction project.

In accordance with another embodiment of the invention, a computer-implemented method for training an artificial-intelligence (AI) structure and automatically generating, by the trained AI structure, actual designs based on inputs related to an actual fabrication or construction project, comprises:
providing existing data of past fabrication or construction projects from a design database to an autoencoder of the AI structure, the autoencoder comprising a first encoder and a first decoder, the existing data comprising a plurality of data sets comprising at least one of past designs and past inputs;
encoding and decoding, by the autoencoder, the existing data, i.e. at least a subset of the plurality of data sets, to learn a representation of the existing data or the data sets in a low-dimensional space, wherein the encoding and decoding of the data sets comprises an encoding, by the first encoder, of the data sets to low-dimensional representations, and a decoding, by the first decoder, of the low-dimensional representations;
providing actual input data related to an actual fabrication or construction project to an encoder-decoder pair comprising either the first encoder and a second decoder or the first decoder and a second encoder;
encoding and decoding, by the encoder-decoder pair, the actual input, wherein the encoding and decoding of the data sets comprises an encoding of the actual input to an actual low-dimensional representation and a decoding of the actual low-dimensional representation; and
generating output data based on the result of the decoding of the actual low-dimensional representation.

In various alternative embodiments, the output data is presented to a user of the system and/or stored in a computer-readable medium of the system.

Additionally or alternatively, the output data comprises at least one of:
resource ID of components in each task;
construction activity;
expected start and end date;
equipment involved;
pre-requirements; and
cost.

Additionally or alternatively, the AI structure is or comprises a neural network structure, e.g. comprising a generative adversarial network (GAN).

In some embodiments, the encoder-decoder pair comprises the first decoder and a second encoder, the existing data comprises a plurality of past designs generated by one or more human designers, providing the existing data comprises providing the past designs to the autoencoder, and based on the encoding and decoding of the plurality of past designs, the autoencoder learns a representation of the past designs in a low-dimensional space.

Optionally, each design comprises at least an IWP of a fabrication or construction project and a schedule for the IWP.

Additionally or alternatively, the plurality of data sets comprises at least 100 past designs, and the autoencoder encodes and decodes at least 100 past designs to learn a representation of the past designs in a low-dimensional space.

In some embodiments, the encoder-decoder pair comprises the first encoder and a second decoder, the existing data comprises a plurality of past inputs comprising at least one of lists of crews and components of past fabrication or construction projects, providing the existing data comprises providing the past inputs to the autoencoder, and based on the encoding and decoding of the plurality of past inputs, the autoencoder learns a representation of the past inputs in a low-dimensional space.

Additionally or alternatively, the actual input data comprises at least one of lists of crews and components of the actual fabrication or construction project.

Additionally or alternatively, the plurality of data sets comprises at least 10 data sets or at least 100 data sets.

In some embodiments, the method further comprises:
providing the output data to a user,
determining, by the user, whether given constraints are violated by the output data and providing, by the user, feedback comprising information on whether a constraint is violated, and
using the feedback for a reinforced learning process in the training of the AI structure.

Additionally or alternatively, the method further comprises:
providing the output data to a simulation software,
determining, by the simulation software, whether given constraints are violated by the output data and providing, by the simulation software, feedback comprising information on whether a constraint is violated, and
using the feedback for a reinforced learning process in the training of the neural network structure.

Optionally, the feedback may be codified in terms of a reward function for a Q-learning-approach and/or may comprise information on whether a constraint is violated.

Additionally or alternatively, the method further comprises:
generating, based on past design inputs and using one or more metaheuristic algorithms, a multitude of design alternatives, and
using the multitude of design alternatives in the training of the AI structure.

Additionally or alternatively, the method further comprises generating, based on the output data and using one or more metaheuristic algorithms, an optimal design for the actual fabrication or construction project.

In accordance with another embodiment of the invention, a computer program product comprises a tangible, non-transitory computer readable medium having embodied therein a computer program which comprises program code that, when run on a computer, is configured to perform the above-specified method.

### BRIEF DESCRIPTION OF THE DRAWINGS

Those skilled in the art should more fully appreciate advantages of various embodiments of the invention from the following “Description of Illustrative Embodiments,” discussed with reference to the drawings summarized immediately below.

FIG. 1 is a simplified schematic diagram of a Smart Virtual Designer system in accordance with certain exemplary embodiments.

FIG. 2 is a simplified schematic diagram illustrating a functionality of a Smart Virtual Designer system using a metaheuristic approach in accordance with certain exemplary embodiments.

FIG. 3 is a simplified schematic diagram illustrating a functionality of a Smart Virtual Designer system using a reinforcement learning approach in accordance with certain exemplary embodiments.

FIG. 4 is a simplified schematic diagram illustrating a functionality of a first Smart Virtual Designer system using a generative approach in accordance with certain exemplary embodiments.

FIG. 5 is a simplified schematic diagram illustrating a functionality of a second Smart Virtual Designer system using a generative approach in accordance with certain exemplary embodiments.

FIG. 6 is a simplified schematic diagram illustrating a functionality of a first exemplary embodiment of an autoencoder of a Smart Virtual Designer system in accordance with certain exemplary embodiments.

FIG. 7 is a simplified schematic diagram illustrating a functionality of a second exemplary embodiment of an autoencoder of a Smart Virtual Designer system in accordance with certain exemplary embodiments.

### DESCRIPTION OF ILLUSTRATIVE EMBODIMENTS

A process-engineering project comprises a set of design decisions. Although in prior art solutions, some tools exist that allow automation of the design phase, the construction phase is still left with many manual and experience-related decisions, even though there is an abundance of design automation software. All design decisions are made with the help of design automation software in a consistent database. Facing a problem, the human engineer weights the alternatives and makes a decision, using his or her experience, i.e. decisions that have been proven correct in the past. By studying these decisions, with the help of machine-learning techniques, a software is created that helps engineers with this job. As discussed below, this can be done using a generative and evolutionary (genetic programming) approach, a reinforcement learning approach or a generative approach. The process can be optimized and the automated design approach leveraged.

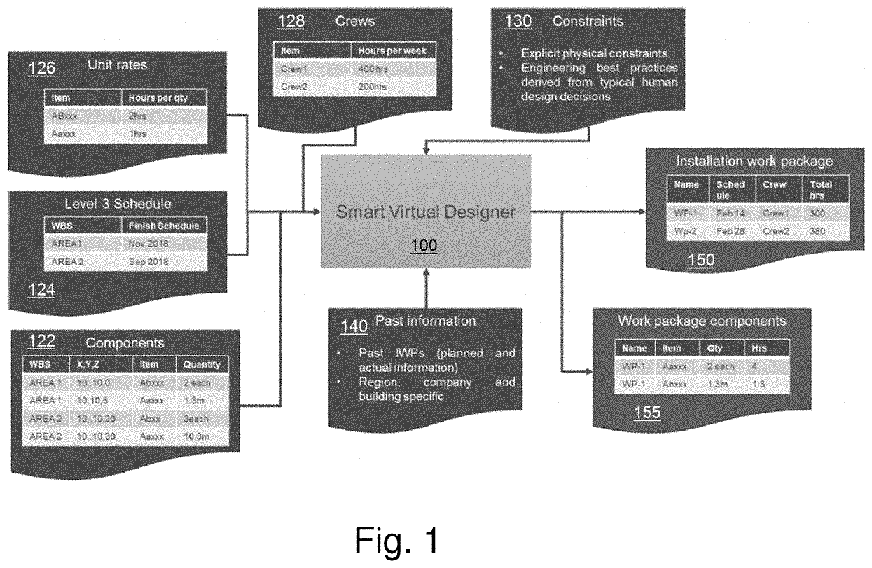

FIG. 1 shows an exemplary embodiment of a Smart Virtual Designer 100, which is a software tool that provides a human designer a full and complete list of Installation Work Packages (IWP) 150. As illustrated in FIG. 1, the Smart Virtual Designer 100 is a tool which takes all information available 122, 124, 126, 128 into account and generates IWP 150 and their schedule. This can be done in different variants. In all cases, the Smart Virtual Designer 100 aims at providing all IWP 150 with their schedule to the user of the software.

The Smart Virtual Designer 100 may learn over time from human designer decisions (i.e. past designs) 140 and can also learn on its own, based e.g. on human feedback or as part of an optimization process for minimizing e.g. cost, downtime or several factors at once with individual weighting.

The Smart Virtual Designer 100 generates IWP 150 that mimic human designs but have e.g. a cost benefit due to small behavioral changes compared to human designer decisions which can be achieved by not only learning from one individual designer's decisions but from several designers' decisions.

The Smart Virtual Designer 100 can provide updates to the IWP 150 e.g. on a daily base and take delays e.g. due to weather or lack of crew into account. The Smart Virtual Designer model may either be trained globally or company-specific but deployed as part of a construction designing software and can be run locally. Alternatively, the Smart Virtual Designer 100 can be deployed to a cloud-like architecture and designs be generated online and downloaded to the local contractor.

On the input site, normally there is plenty of data available that must be considered. This data may be available in tabular data (e.g. spreadsheets) so that is can be extracted and used easily by the Smart Virtual Designer. In some embodiments, these input data comprise:
components data 122, i.e. type, size and dimensions, material, weight, location, requirements, etc.;
overall schedules, such as a Level 3 schedule 124;
technical resources available, i.e. resource ID, labor rate per unit 126, expected availability and supplier information, manufacturer, specializations, etc.;
crew availability 128 and labor costs;
construction activity, e.g. at other CWA and in other CWP;
design schematics, e.g. a 3D design plan with spatial location of objects and their physical connections etc.;
explicit design rules derived from physical constraints 130 and implicit best practices and design rules, i.e. build from larger items to smaller items (e.g. first place the tank, then the pipes around it), build from ground up, build from heavy to light, from expensive to cheaper etc.;
further constraints such as maximum number of workers in one place, earliest starting date, latest finishing date;
human designer decisions 140, i.e. past IWP and their schedule that were designed manually;
actual vs. planned information, i.e. derivations from past planned IWP such as derivations due to weather, unexpected downtime or delivery delays etc.; and
local information, e.g. comprising legal requirements (e.g. regarding labor conditions), expected delays due to inaccuracy in availability information or typical weather delays, different crews, distributors etc.

On the output site, there is a definition of work packages (IWP) 150 with their components 155 and scheduling. In some embodiments, the outputs comprise:
resource ID of components in each task;
construction activity;
expected start and end date;
equipment involved (i.e. tools and crew);
pre-requirements (e.g. other work packages that need to be completed before);
cost (total and of individual packages); and
other quality factors such as downtime etc.

Optionally, the output may be provided to the user by means of a video stream.

The IWP 150 created by the Smart Virtual Designer 100 are—unlike (purely) human designed ones—automatically practical, i.e. the generated IWP 150 follow all constraints 130 and can be executed in the given order and without further review needed. The IWP 150 are codified in tabular data (e.g. spreadsheets) and can be integrated or loaded into the regular designing software.

For integrating the Smart Virtual Designer 100 into existing workflows, in general five different aspects have to be considered:

### 1. Design,

2. layout,
3. planning,
4. schedule and
5. execution.

The design is composed by the known inputs, i.e. objects, components lists and the like. The layout is described by the IWP. Planning refers to a Gantt chart of a sequence of IWP. In the schedule, an operation schedule schedules construction events down to a daily or even hourly base. In the execution, a change report is generated specifying what was installed during a certain period, typically a day.

The Smart Virtual Designer 100 can be used at any of these stations and support (or even replace) the human designer and planner. In an ideal construction, this workflow would be linear and consecutive. First, there is a design of a large structure such as a plant. Then, the construction is lay-outed and planned. Based thereon, a schedule for the workers is generated, and after each working day a change report ticks off all the planned construction objects. However, problems will occur at each of these stages and cause additional work—potentially also at all other stages. Hence, this is a rather iterative process, which causes a lot of manual work for the engineers. The Smart Virtual Designer 100 can automatically integrate all these stages and update each stage fast and efficiently.

When a construction project goes according to plan with each change report, items can be ticked off at the operation schedule, in the Gantt chart, in the IWP and from the remaining list of objects. However, as soon as there is a delay or some unexpected change in the change report, there is a need to re-plan at all these stages. Furthermore, on all other stages unexpected changes could occur as well. Examples are provided below. The Smart Virtual Designer helps mitigating these issues.

Whenever there is an unexpected change at the design level (e.g. when parts are exchanged or the design of a plant needs to be updated), usually all other stages are subject to change, too. Thus, for every update in the design, the IWP and schedule need to be updated. Based thereon, new operation schedules are derived and, consequently, the change reports will be different. Here, the Smart Virtual Designer can generate updated IWP and their schedule without the need for a human engineer to manually plan again. This results in cost and timing benefits. The Smart Virtual Designer allows for dynamic planning and can easily generate new IWP and schedules daily, thus allowing a more efficient construction with up-to-date plans and schedules. Furthermore, as the Smart Virtual Designer solutions can automatically be checked whether they are feasible, constructions are not delayed by inaccurate or unfeasible IWP or schedules. This is a problem which currently can occur as a result of human error. Hence, the Smart Virtual Designer eliminates issues within these two stages.

On the scheduling and execution side, various unexpected changes can occur every day. Due to simple facts—such as changing weather, changes to crew availability (e.g. due to sickness) or delays—change reports often are intensive and provide information on works which were planned but not executed. This causes a need to re-plan the operation schedule or as soon as delays are larger to change the IWP and Gantt charts. Currently, this is a manual and time-consuming task. Thus, the human designers try to avoid any changes to the IWP and schedules as far as possible. Using the Smart Virtual Designer, change reports can be read and processed automatically in order to generate updates to the operation schedule, IWP or Gantt charts without effort and whenever needed. Therefore, workers always work with the most accurate plan and the engineers and designers are always aware of the status of the construction.

Another aspect to the Smart Virtual Designer is auxiliary works. Currently, auxiliary works and processes such as putting up scaffoldings or setting up barriers is not part of the design or planning phase of a construction. These are implicit tasks that the designer has in mind and which the workers perform during construction but that are not part of the components list. Hence, there are no IWP that take auxiliary works into account. With the Smart Virtual Designer this could be done. As it is known for which parts which auxiliary works need to be done, they could be integrated into the design and, thus, be considered by the Smart Virtual Designer. The Smart Virtual Designer can more easily than a human designer cope with the resulting increase in complexity.

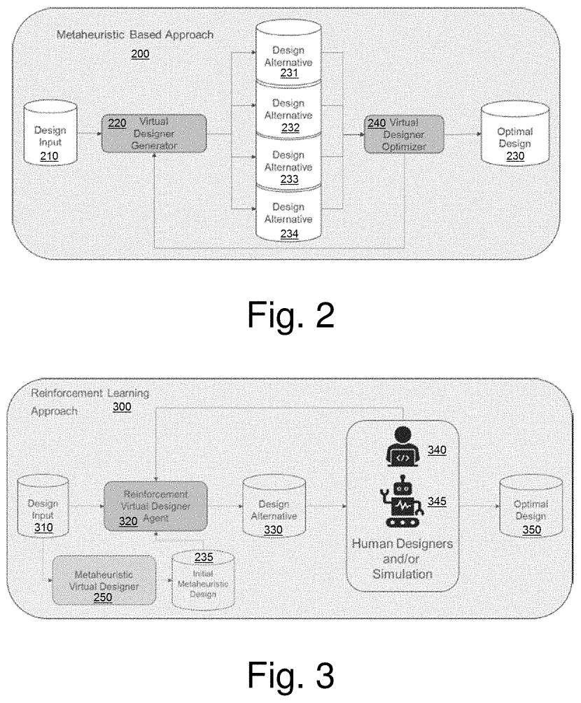

There are several different possibilities on how the Smart Virtual Designer can generate designs. Some of these methods are illustrated with respect to the FIGS. 2, 3, 4 and 5.

FIG. 2 illustrates a first exemplary embodiment of a method using a metaheuristic-based approach for the Smart Virtual Designer 200. Using a virtual designer generator 220 with metaheuristic algorithms (such as genetic algorithms, evolutionary programming, stimulated annealing etc.) based on design input 210 design alternatives 231-234 could be generated that fulfil all given constraints but do not take into account human behaviour, i.e. human designers' previous decisions and past designs. These generated solutions then evolve over time (i.e. computational time), e.g. in an iterative process using a virtual designer optimizer 240, and eventually converge to feasible designs minimizing e.g. costs, crew downtimes, robustness (critical path) and the like. Based on the constraint set, other learning methods such as decision trees can be used as well to generate optimal designs 230, e.g. optimal IWP.

Alternatively, based on an initial model trained like above fulfilling the given constraints one could use reinforcement-learning techniques and generate solutions where a human designer gives feedback. Referring to FIG. 3, a second exemplary embodiment of a method using such a reinforcement-learning approach for the Smart Virtual Designer 300 is illustrated.

Said feedback of the designer could be binary, i.e. in the form “accept design” or “revoke design”. Furthermore, the human designer 340 could give feedback in terms of some metrics like: How human-like is the solution? How much does the solution deviate from what the local crews are used to do (in terms of e.g. sequencing)? This could be codified in terms of a reward function for a Q-learning-approach, training neural networks or a Q-table. Also, SARSA or Monte-Carlo-based algorithms are possible.

In reinforcement learning, one can use Q-learning with the use of Q-tables to learn the reward for explicit combinations of state and action. Also, a neural network architecture can be used instead of a Q-table. Both the Q-table and the neural network are trained to predict the Q-function Q(s,a)—i.e. the reward of taking action a in state s. The Q-table represents the Q-function as a look-up table, i.e. an exact mapping of states seen during training to actions. Thus, it does not adapt to unseen states and cannot provide predictions on such. That is where neural networks known as function approximators come into play. The neural network provides the flexibility to adapt to unseen states and moreover scales well to large state action spaces. The reward function for a neural network is (as when using a Q-table) used, to update these Q-value. A Q-table is learned using the reward function and Bellmann equation. A neural network is also learned by using the reward function but then uses backpropagation to update the network weights.

Instead of human feedback, a Q-learning-approach can also be used based on the constraints and feedback can be given to a reinforcement virtual designer agent 320 in terms of whether a constraint is violated or not. This approach would generate design alternatives 330 not on a metaheuristic approach 200 as described with respect to FIG. 2 but purely on its own, where a reward function would e.g. codify which and how many constraints are violated. This would be set by the simulation environment where the constraints are given as above, and the agent 320 could then explore the action space towards first a feasible and—in a second or more steps—even optimal solution 350. The agent 320 decides which parts to select in an IWP, which crew or crews to assign to and schedules start and finish date, thus, generating a sequence of many IWP iteratively. In each step, feedback is given by either a human 340 or a simulation software 345 in terms of a reward function with regards to any subset of the above listed possibilities. The agent 320 is fed with the information on crew availability, parts etc. The physical constraints may be integrated in the simulation software or checked by humans and learned as part of their feedback and without explicit knowledge of these to the agent itself. By the given feedback, the agent is reinforced in its decisions so that it learns over time. The Smart Virtual Designer can learn and improve its decisions over several construction projects and within a single construction project. The simulation software 345 may know constraints like the physical fundamentals or security regulations and determines whether these constraints are violated by the provided design alternative 330.

Reinforcement learning works by exploring possible actions and receiving feedback for each action in the form of a reward and by that implicitly learning the underlying logic and dynamics of a system to eventually outperform classical approaches. The learning is decoded using e.g. a neural network, Q-tables or other methods. The entries of the Q-table and the weights of a neural network are initialized randomly at the beginning but get updated iteratively based on the feedback decoded in the reward function. The agent 320 selects a single component and sorts it into a working package and assigns a crew to it. After each individual action or after several individual actions (e.g. whenever an individual IWP is “completed” (i.e. no more components get added to the same IWP) this is sent into a simulation which gives a reward. Either a simulation 345 or a human designer 340 or both could be rating the selection of the agent 320. The reward is a real scalar but can take several aspects into account. A simulation engine could check the output 330 by the agent 320 on whether it is feasible, i.e. whether any physical constraints are violated. Furthermore, the simulation environment puts out a state to the agent. This state defines the remaining components, crews etc. The agent then selects a new action based on the updated reward and state.

In one special embodiment, the metaheuristic approach 200 of FIG. 2 can be integrated into the reinforcement learning approach 300. A metaheuristic virtual designer 250 that comprises the functions of the metaheuristic approach 200 outputs based on the design input one or more initial metaheuristic design 235 that might correspond to the design alternatives 231-234, to a feasible design or an optimal design 230 of the metaheuristic approach 200. This initial metaheuristic design 235 is provided to the reinforcement virtual designer agent 320.

In general, reinforcement learning is potentially able to outperform classical solutions like decisions trees or traditional optimization techniques when there is a massive combinatorial search space, a clear objective function or metric to optimize against and either lots of data or an accurate and efficient simulator. In the case of Construction Sequencing Optimization there is a massive combinatorial search space. Selecting an individual component in each step, assigning it to an IWP and then doing this for all components is a massive combinatorial task with almost endless complexity. There is a clear metric to optimize against. This is cost, critical path stability, downtime and whether constraints are violated. This could all be added (linear or weighted) into a sum which would then be optimized jointly. Furthermore, that way dynamic constraints could be embedded, where a violation of constraints is penalized differently over different actions. There is past data available and a simulation is possible. More specifically, past designs can be used to initially train a reinforcement approach. In a first training step, a neural network could be trained using past problems, i.e. training a network based on a supervised approach to have a better starting point than random initialization when proceeding to a reinforcement setup. One important choice is the choice of a proper reward function. Reinforcement learning works well where there are a clear objective as well as clear “game over” actions. In the case of construction sequencing optimization, proper objectives are minimizing costs, labor, downtime etc. Furthermore, a “game over” status would be reached as soon as an action violates a physical constraint.

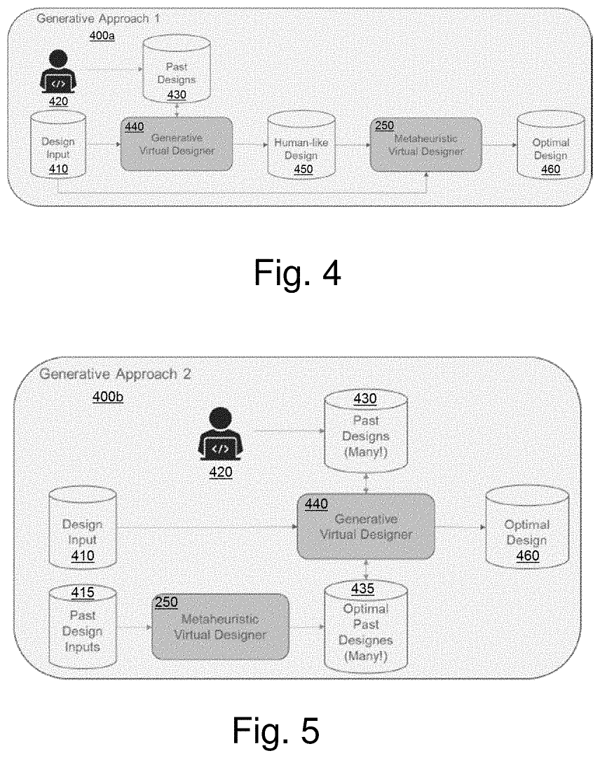

Another approach makes use of previously generated designs (“past designs”) in a generative model using supervised machine learning. Referring to FIGS. 4 and 5, further exemplary embodiments of a system and method are illustrated, wherein such a generative approach 400a, 400b is used.

Generally speaking, machine learning (ML) is the application of Artificial Intelligence (AI) to provide software systems with the ability to learn and improve themselves from experience and without being explicitly programmed. Instead, the programmer models the problem to be solved rather than programming the solution itself, and the ML model is trained to perform a given task based on sample data (referred to as “training data”) in order to learn how to produce a particular type output based on particular types of inputs. Thus, machine learning is useful for hard-to-solve problems that may have many viable solutions. ML solutions can exhibit non-expected behavior due to the AI and can improve over time based on additional training data accumulated over time.

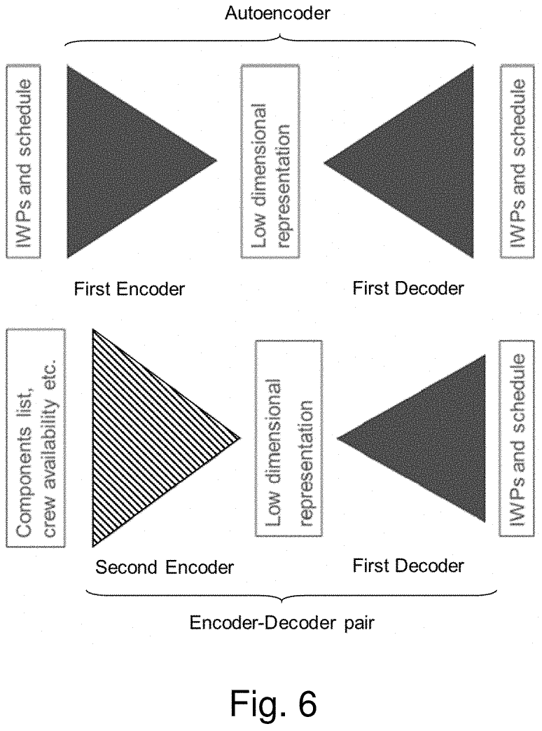

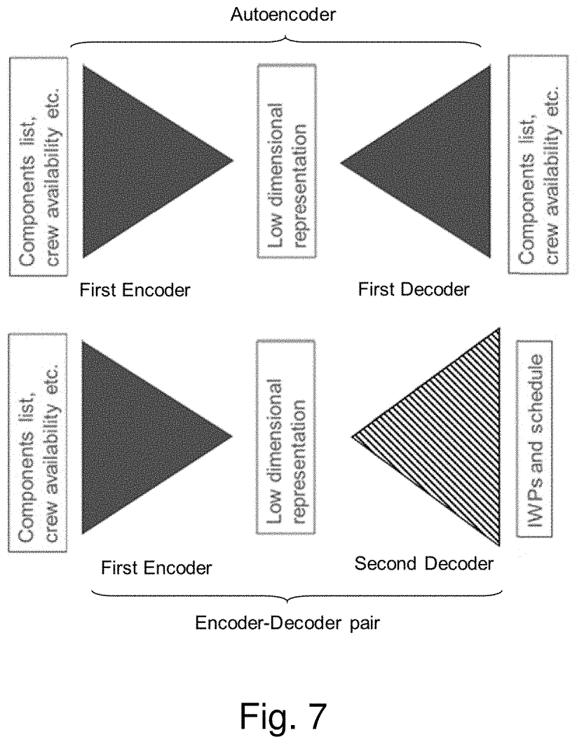

In a first training step of a method encompassing the generative approach, previously created designs 430, i.e. past IWP and their schedule, are provided as input to a generative virtual designer 440. The previously created designs 430 may be created by a human designer 420 for the same or previous projects. The generative virtual designer 440 comprises an autoencoder (exemplary autoencoders are described further below with reference to FIGS. 6 and 7) or a neural networks system that may be used similarly, such as, for instance, a generative adversarial network (GAN).

An autoencoder learns to compress data from an input into an encoding, and then uncompress that encoding into an outcome that closely matches the original data. This forces the autoencoder to engage in dimensionality reduction, for example by learning how to ignore noise. The decoder learns to decode the representation, also referred to as embedding, back into its original form as closely as possible.

A typical training algorithm for an autoencoder can be summarized as:
For each input x,
   do a feed-forward pass to compute activations at all hidden layers, then at the output layer to obtain an output x′,
   measure the deviation of x′ from the input x by a loss function (such as mean square or absolute error, quadratic loss, cross entropy loss or negative log likelihood),
   backpropagate the error through the net and perform weight updates.

The autoencoder of the generative virtual designer 440 comprises an encoder and a decoder that, in a first training phase, encode and decode the past IWP 430. That way, a representation of the IWP in some low-dimensional space, i.e. a so-called encoding or embedding, can be learned.

In a second training phase, the autoencoder's original encoder is replaced by a different encoder that is provided with the actual design inputs 410 for the actual project. The actual design inputs may comprise lists of crews, components and the like. The new encoder encodes these to a low-dimensionality representation. Then, the previously learned decoder (i.e. the autoencoder's original decoder) generates human-like designs 450, e.g. comprising IWP and their schedule. Thus, a neural network structure is trained which can generate IWP based on the inputs 410 automatically.

Human designers' 420 decisions are that way implicitly learned. Typical design inputs 410 get related to typical design decision outputs. Furthermore, not only the planned past designs 430 but the actually used past designs (i.e. after changes due to uncertain events such as weather changes) can be used, too.

Also, the metaheuristic approach 200 illustrated in FIG. 2 can be used to generate further design alternatives 230 which might not be human-like designs 450 but result in fewer costs (or some other optimization benefits) and be used to train the autoencoder as well. This is indicated in FIG. 5, where past design inputs 415 are used by a metaheuristic virtual designer 250 to create a multitude of already “optimal” past designs 435 and provides these to the generative virtual designer 440. Also a multitude of past designs 430 is needed for this approach, for instance tens or hundreds of past designs (i.e. at least between 10 and 100 past designs). That way the neural network not only mimics human behavior but can merge human behavior and potential optimization benefits from metaheuristic approaches into better but still human-like designs.

This approach could take e.g. only customer- or country-specific input into account, so that it can be targeted directly to a certain customer or market. As such information could also be codified, they could also be integrated in the feedback for an agent for a reinforcement learning approach 300 as well as for metaheuristic algorithms. Besides, the opposite way around is possible, too: A neural network learns to relate inputs to final IWP, and metaheuristics use these as starting points to evolve the initial IWP to IWP more optimal with regard to an optimization criterion such as costs.

When new information is available (e.g. which IWP have been completed on a certain day) the design inputs 410 to the Smart Virtual Designer get updated and, hence, a new optimal design 460 can be generated. That way an optimal design schedule is available constantly throughout the whole construction project. The innovation of the Smart Virtual Designer brings a set of benefits that grows with time. As the Smart Virtual Designer learns, it can propose a solution to the human designer and acts as an aid to the process. As many human specialists interact simultaneously with the Smart Virtual Designer (in its generative or reinforcement setup), the learning process helps to bring and spread the best design decisions among the team with the virtual proposals.

FIGS. 6 and 7 each show an autoencoder and an encoder-decoder pair as exemplary tools that can be used in the generative approach of FIGS. 4 and 5. An autoencoder is a twofold mapping that maps from a high-dimensional input to a low-dimensional representation, i.e. to a space where ideally all (but not necessarily all) information is contained but in a space of lower dimension. This is like a compression but with no theoretical guaranties whatsoever on potential losses and recovery. This low-dimensional representation does not have any physical meaning. Rather, the idea is to find an embedding of the original data in a lower-dimensional space. After mapping to a low-dimensional space there follows a mapping back to the original dimensionality of the input. The idea is to encode the data and then decode it back to its original form. Such a network is trained with giving an input and then predicting the very same input again. In the given case of construction sequencing optimization, such an autoencoder is trained with previous design plans. A plan of IWP and their schedule is something that can be codified in a tabular way and hence be inputted to a neural network. Then—either with the use of fully connected layers or convolutional filters and the like—the dimensionality is reduced over several layers and then increased again.

Once such an autoencoder is trained, the original encoder (here: the first encoder) is not needed any more. As the aim of construction sequencing optimization is not mimicking plans but actually creating new ones, the first part of the network (i.e. the encoder) can be discarded to keep only the decoder. Instead of the original encoder, a new network may be built where the inputs (i.e. components list, crew availability, parts information etc.) are taken and mapped towards the same low dimensional space where the previous encoder has mapped to and then have the decoder (i.e. the same decoder as before) decode from this low-dimensional representation back to the IWP dimension. This network would then be trained by keeping the structure and weights of the decoder fixed. This would also be a supervised setup where instead from previous plan to previous plans the system learns from previous inputs to previous plans.

The encoder-decoder pair illustrated in the lower part of FIG. 6 encodes the inputs, i.e. component lists etc., to a low dimensional representation, the so-called embedding, and then decodes from there to IWP. The autoencoder illustrated in the upper part of FIG. 6 is only a vehicle to break down the learning of the encoder-decoder into two feasible parts, i.e. first learning an autoencoder, then using the decoder of which (first decoder) as a part of the encoder-decoder pair, later learning another encoder (second encoder) to complete the encoder-decoder pair. After this training, only the encoder-decoder pair is needed.

As illustrated in FIG. 7, the training of the autoencoder can also be inversed. The autoencoder illustrated in the upper part of FIG. 7 (in contrast to that of FIG. 6) is trained on the input level, i.e. from input to inputs. The autoencoder's encoder (first encoder) together with another decoder (second decoder) forms the encoder-decoder pair in this embodiment.

After training first the autoencoder and then the new encoder or decoder in this so-to-say updated autoencoding structure, a network exists that can map from new inputs to IWP and schedules. Furthermore, this low-dimensional representation allows to measure the distance between two designs or two inputs. The closer these inputs are embedded in the low-dimensional representation the more alike they are. One issue with this setup is that physical constraints are not considered. The idea is to implicitly learn these constraints because they have been obeyed in previous designs and that way are somehow learned and decoded in the network structure. Still, there is no guarantee that a final solution would be feasible.

Furthermore, this approach will eventually mimic human designers but not necessarily outperform human-generated solutions. Therefore, another optimization step would be needed (Generative Approach 1 of FIG. 4). Here, generative algorithms could be used or other more traditional rule-based algorithms. Based on a metaheuristic solver one can also generate some IWP for previous inputs and then use these solutions as training data (Generative Approach 2 of FIG. 5). This way the network could outperform human behavior while still being close to human design principles. However, there is also no guarantee that no constraints will be violated—only a high likeliness that these constraints are implicitly learned. Both approaches perform the better the more previous data is available. Besides, they can learn over time as new inputs and IWPs can be constantly used to retrain the network.

Although the above discussion discloses various exemplary embodiments of the invention, it should be apparent that those skilled in the art can make various modifications that will achieve some of the advantages of the invention without departing from the true scope of the invention. Any references to the “invention” are intended to refer to exemplary embodiments of the invention and should not be construed to refer to all embodiments of the invention unless the context otherwise requires. The described embodiments are to be considered in all respects only as illustrative and not restrictive.

1. A smart virtual designer system for construction sequencing optimization, wherein the system is configured to train an artificial-intelligence structure to automatically generate actual designs based on inputs related to an actual fabrication or construction project, the system comprising:
a design database storing existing data of past fabrication or construction projects, the existing data comprising a plurality of data sets comprising at least one of past designs and past inputs; and
at least one server comprising a tangible, non-transitory computer-readable medium having stored thereon a generative virtual designer comprising the neural network structure including at least an autoencoder and an encoder-decoder pair, the autoencoder comprising a first encoder and a first decoder and the encoder-decoder pair comprising either the first encoder and a second decoder or the first decoder and a second encoder;
wherein:
the design database and the server are configured to interact so that the existing data are provided to the autoencoder;
the autoencoder is configured to encode and decode at least a subset of the plurality of data sets to learn a representation of the data sets in a low-dimensional space, wherein the encoding and decoding of the data sets comprises an encoding, by the first encoder, of the data sets to low-dimensional representations, and a decoding, by the first decoder, of the low-dimensional representations;
the system comprises a data input device configured to receive actual input data related to an actual fabrication or construction project and to provide the actual input data to the encoder-decoder pair;
the encoder-decoder pair is configured to encode the actual input data to an actual low-dimensional representation and to decode the actual low-dimensional representation;
the system is configured to generate output data based on the result of the decoding of the actual low-dimensional representation.

2. The system of claim 1, wherein:
the output data is presented to a user of the system and/or stored in the computer-readable medium.

3. The system of claim 1, wherein the output data comprises at least one of:
resource ID of components in each task;
construction activity;
expected start and end date;
equipment involved;
pre-requirements; and
cost.

4. The system of claim 1, wherein:
the artificial intelligence structure is or comprises a neural network structure.

5. The system of claim 4, wherein:
the neural network structure comprises a generative adversarial network.

6. The system of claim 1, wherein:
the encoder-decoder pair comprises the first decoder and a second encoder;
the existing data comprises a plurality of past designs generated by one or more human designers;
the design database and the server are configured to interact so that the past designs are provided to the autoencoder; and
based on the encoding and decoding of the plurality of past designs, the autoencoder learns a representation of the past designs in a low-dimensional space.

7. The system of claim 6, wherein:
each design comprises at least an Installation Work Package (IWP) of a fabrication or construction project and a schedule for the IWP.

8. The system of claim 6, wherein:
the plurality of data sets comprises at least 100 past designs, and
the autoencoder is configured to encode and decode at least 100 past designs to learn a representation of the past designs in a low-dimensional space.

9. The system of claim 1, wherein:
the encoder-decoder pair comprises the first encoder and a second decoder;
the existing data comprises a plurality of past inputs comprising at least one of lists of crews and components of past fabrication or construction projects;
the design database and the server are configured to interact so that the past inputs are provided to the autoencoder; and
based on the encoding and decoding of the plurality of past inputs, the autoencoder learns a representation of the past inputs in a low-dimensional space.

10. The system of claim 9, wherein:
the actual input data comprises at least one of lists of crews and components of the actual fabrication or construction project.

11. A computer-implemented method for training an artificial-intelligence structure and automatically generating, by the trained artificial-intelligence structure, actual designs based on inputs related to an actual fabrication or construction project, the method comprising:
providing existing data of past fabrication or construction projects from a design database to an autoencoder of the artificial-intelligence structure, the autoencoder comprising a first encoder and a first decoder, the existing data comprising a plurality of data sets comprising at least one of past designs and past inputs;
encoding and decoding, by the autoencoder, at least a subset of the plurality of data sets to learn a representation of the data sets in a low-dimensional space, wherein the encoding and decoding of the data sets comprises an encoding, by the first encoder, of the data sets to low-dimensional representations, and a decoding, by the first decoder, of the low-dimensional representations;
providing actual input data related to an actual fabrication or construction project to an encoder-decoder pair comprising either the first encoder and a second decoder or the first decoder and a second encoder;
encoding and decoding, by the encoder-decoder pair, the actual input, wherein the encoding and decoding of the data sets comprises an encoding of the actual input to an actual low-dimensional representation and a decoding of the actual low-dimensional representation; and
generating output data based on the result of the decoding of the actual low-dimensional representation.

12. The method of claim 11, further comprising:
presenting the output data to a user and/or storing the output data in a computer-readable medium.

13. The method of claim 11, wherein the output data comprises at least one of:
resource ID of components in each task;
construction activity;
expected start and end date;
equipment involved;
pre-requirements; and
cost.

14. The method of claim 11, wherein:
the artificial intelligence structure is or comprises a neural network structure.

15. The method of claim 11, wherein:
the encoder-decoder pair comprises the first decoder and a second encoder;
the existing data comprises a plurality of past designs generated by one or more human designers;
providing the existing data comprises providing the past designs to the autoencoder; and
based on the encoding and decoding of the plurality of past designs, the autoencoder learns a representation of the past designs in a low-dimensional space.

16. The method of claim 15, wherein:
each design comprises at least an Installation Work Package (IWP) of a fabrication or construction project and a schedule for the IWP.

17. The method of claim 15, wherein:
the plurality of data sets comprises at least 100 past designs, and
the autoencoder encodes and decodes at least 100 past designs to learn a representation of the past designs in a low-dimensional space.

18. The method of claim 11, wherein:
the encoder-decoder pair comprises the first encoder and a second decoder;
the existing data comprises a plurality of past inputs comprising at least one of lists of crews and components of past fabrication or construction projects;
providing the existing data comprises providing the past inputs to the autoencoder; and
based on the encoding and decoding of the plurality of past inputs, the autoencoder learns a representation of the past inputs in a low-dimensional space.

19. The method of claim 18, wherein:
the actual input data comprises at least one of lists of crews and components of the actual fabrication or construction project.

20. The method of claim 11, comprising:
generating, based on past design inputs and using one or more metaheuristic algorithms, a multitude of design alternatives, and
using the multitude of design alternatives in the training of the artificial-intelligence structure.

21. The method of claim 11, comprising:
generating, based on the output data and using one or more metaheuristic algorithms, an optimal design for the actual fabrication or construction project.

22. A computer program product comprising a tangible, non-transitory computer readable medium having embodied therein a computer program which comprises program code that, when run on a computer, is configured to perform the method of claim 11.
